(19) United States
(12) Patent Application Publication
(10) Pub. No.: US 2023/0153827 A1
(43) Pub. Date: May 18, 2023

(54) METHODS AND INTERNET OF THINGS SYSTEMS FOR SMART GAS INSTALLATION MANAGEMENT

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Xiaojun WEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/152,175

(22) Filed: Jan. 10, 2023

(30) Foreign Application Priority Data
Dec. 21, 2022 (CN) 202211644553.1

(51) Int. Cl. G06Q 30/015; G16Y 40/35; G16Y 10/35

(52) U.S. Cl. CPC G06Q 30/015; G16Y 40/35; G16Y 10/35; G06Q 50/06

(57) ABSTRACT

The embodiments of the present disclosure provide methods and Internet of Things system for smart gas installation management. The method may be implemented based on the Internet of Things system for smart gas installation management. The method may include: obtaining user installation information, wherein the user installation information includes at least one of user information or property information; determining whether to accept a gas installation based on the user installation information and an acceptance condition; in response to acceptance of the gas installation, determining, based on a user requirement and a staff availability degree, overall service intensity of the Internet of Things system for smart gas installation management; and determining a door-to-door service plan based on the overall service intensity.

### CROSS-REFERENCE TO RELATED APPLICATIONS

This application claims priority of Chinese Patent Application No. 202211644553.1, filed on Dec. 21, 2022, the entire contents of which are hereby incorporated by reference.

### TECHNICAL FIELD

The present disclosure relates to field of smart gas, and in particular to methods and Internet of Things systems for smart gas installation management.

### BACKGROUND

In some scenarios, such as when moving into a new building, a user usually needs to submit a gas installation. The existing gas installation process is usually performed manually and the process is cumbersome. In addition, due to the limited count of staff for gas installation, when the demand for gas installations is large, it is easy to have unreasonable arrangements of door-to-door service plans of gas installation, such as an unreasonable count of staff, a conflicting door-to-door service time, and an unreasonable service arrangement, which may lead to a relatively long waiting time, etc. for a user.

Therefore, it is desirable to provide methods and Internet of Things systems for smart gas installation management that can provide a convenient and efficient door-to-door installation service.

### SUMMARY

According to one or more embodiments of the present disclosure, a method for smart gas installation management is provided. The method may be implemented based on an Internet of Things system for smart gas installation management. The method may include: obtaining user installation information, wherein the user installation information includes at least one of user information or property information; determining whether to accept gas installation based on the user installation information and an acceptance condition; in response to acceptance of the gas installation, determining, based on a user requirement and a staff availability degree, overall service intensity of the Internet of Things system for smart gas installation management; and determining a door-to-door service plan based on the overall service intensity.

According to one or more embodiments of the present disclosure, an Internet of Things system for smart gas installation management is provided. The Internet of Things system for smart gas installation management may include a smart gas user platform, a smart gas service platform, a smart gas operation management platform, a smart gas sensor network platform, and a smart gas object platform. The smart gas operation management platform may comprise a smart gas indoor installation management sub-platform and a smart gas data center. The smart gas data center is configured to obtain user installation information from the smart gas user platform through the smart gas service platform and sending the user installation information to the smart gas indoor installation management sub-platform; and the smart gas indoor management sub-platform is configured to: obtain the user installation information, wherein the user installation information comprising at least one of user information or property information; determine whether to accept gas installation based on the user installation information and an acceptance condition; in response to acceptance of the gas installation, determine, based on a user requirement and a staff availability degree, overall service intensity of the Internet of Things system for smart gas installation management; and determine a door-to-door service plan based on the overall service intensity.

According to one or more embodiments of the present disclosure, a non-transitory computer-readable storage medium storing computer instructions. When the computer instructions are executed by a processor, the method for smart gas installation management may be implemented.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a structure diagram illustrating an exemplary platform of an Internet of Things system for smart gas installation management according to some embodiments of the present disclosure;

FIG. 2 is a flowchart illustrating an exemplary process for smart gas installation management according to some embodiments of the present disclosure;

FIG. 3 is an exemplary schematic diagram illustrating determining overall service intensity according to some embodiments of the present disclosure;

FIG. 4 is an exemplary schematic diagram illustrating adjusting a count of staff according to some embodiments of the present disclosure; and

FIG. 5 is a flowchart illustrating an exemplary process for determining a door-to-door service plan according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

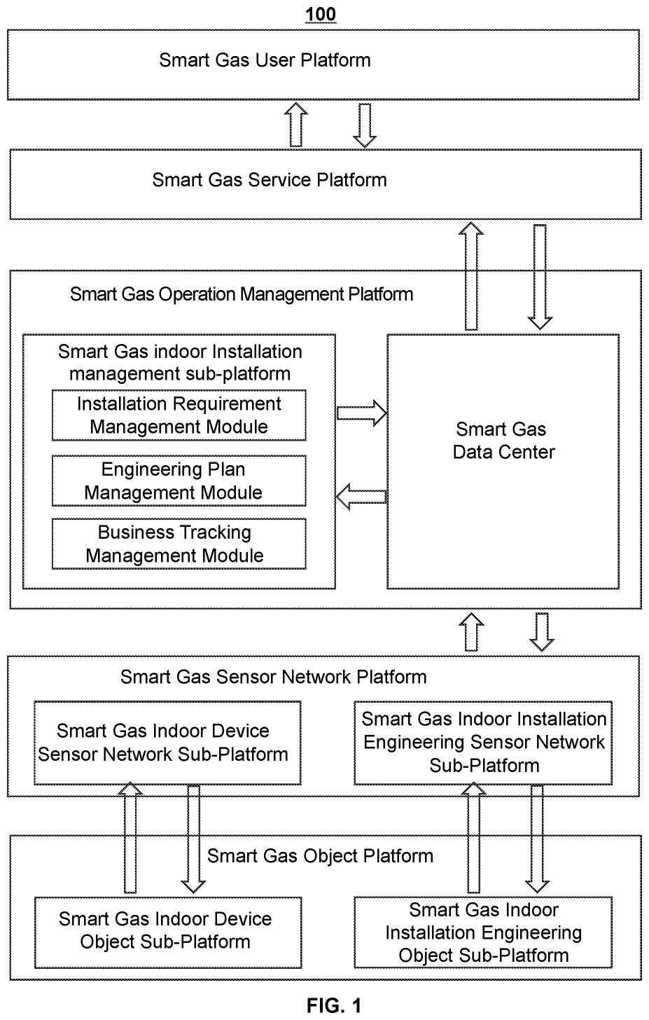

FIG. 1 is a structure diagram illustrating an exemplary platform of an Internet of Things system for smart gas installation management according to some embodiments of the present disclosure. As shown in FIG. 1, the Internet of Things system 100 for smart gas installation management may include a smart gas user platform, a smart gas service platform, a smart gas operation management platform, a smart gas sensor network platform, and a smart gas object platform that interact in sequence.

The smart gas user platform may be a platform configured to interact with a user. The user may be a gas user. In some embodiments, the smart gas user platform may be configured as a terminal device. For example, the terminal device may include a desktop computer, a tablet computer, a laptop computer, a mobile phone, and other smart electronic devices that implement data processing and data communication, which is not much limited herein. In some embodiments, the smart gas user platform may obtain user requirement information through the terminal device, for example, obtain user installation information input by the user.

In some embodiments, the smart gas user platform may interact with the smart gas service platform. For example, the smart gas user platform may transmit the user installation information to the smart gas service platform. As another example, the smart gas user platform may be configured to receive a door-to-door service plan transmitted by the smart gas service platform.

The smart gas service platform may be a platform for receiving and transmitting data and/or information. The smart gas service platform may interact with the smart gas user platform and the smart gas operation management platform. For example, the smart gas service platform may transmit the user installation information to the smart gas operation management platform. As another example, the smart gas service platform may receive the door-to-door service plan transmitted by the smart gas operation management platform.

The smart gas operation management platform may be a platform for overall planning and coordinating connections and collaboration among a plurality of function platforms. In some embodiments, the smart gas operation management platform may include a smart gas data center and a smart gas indoor installation management sub-platform. The smart gas indoor installation management sub-platform may interact with the smart gas data center in a bidirectional manner.

The smart gas data center may aggregate and store all operation data of the Internet of Things system 100 for smart gas installation management. In some embodiments, the smart gas operation management platform may interact with the smart gas sensor network platform and the smart gas service platform through the smart gas data center. For example, the smart gas data center may receive the user installation information from the smart gas service platform and transmit the user installation information to the smart gas indoor installation management sub-platform for processing. As another example, the smart gas data center may receive processed data (e.g., the door-to-door service plan) from the smart gas indoor installation management sub-platform.

The smart gas indoor installation management sub-platform may obtain all the operation data of Internet of Things system 100 for the gas installation management through the smart gas data center and perform an analysis processing on all the operation data. In some embodiments, the smart gas indoor installation management sub-platform may include an installation requirement management module, an engineering plan management module, and a business tracking management module.

The smart gas indoor installation management sub-platform may review the user installation requirement information through the installation requirement management module to generate indoor installation review information (e.g., whether to accept the gas installation review information). The smart gas indoor installation management sub-platform may send the indoor installation review information to the smart gas data center. Further, the smart gas data center may feed the indoor installation review information back to the smart gas user platform through the smart gas service platform, forming a closed information loop between the smart gas user platform and the smart gas operation management platform regarding the installation requirement review management.

The smart gas indoor installation management sub-platform may manage an engineering assignment plan for an approved installation requirement (e.g., an accepted gas installation requirement) through the engineering plan management module to generate a door-to-door service plan. For example, the engineering plan management module may determine overall service intensity of the Internet of Things system 100 for smart gas installation management based on a user requirement and a staff availability degree. Further, the engineering plan management module may determine the door-to-door service plan based on the overall service intensity. The smart gas indoor installation management sub-platform may send the door-to-door service plan to the smart gas data center. Further, the smart gas data center may feed the door-to-door service plan back to the smart gas user platform through the smart gas service platform. The smart gas data center may further feed the door-to-door service plan back to the smart gas object platform through the smart gas sensor network platform for being executed by the subsequent smart gas indoor installation engineering object sub-platform.

The smart gas indoor installation management sub-platform may track, manage, and check an execution progress of the door-to-door service plan through the business tracking management module. For example, the staff may upload installation progress information to the business tracking management module through the smart gas indoor installation engineering object sub-platform, and upload system access information of a newly installed indoor device to the business tracking management module. After obtaining the above information, the business tracking management module may confirm completion of the installation and transmit the completion information to the smart gas user platform through the smart gas service platform for user confirmation.

The smart gas sensor network platform may be a functional platform for managing sensor communication. In some embodiments, the smart gas sensor network platform may be configured as a communication network and a gateway. In some embodiments, the smart gas sensor network platform may interact with the smart gas operation management platform and the smart gas object platform to realize information sensor communication. For example, the smart gas sensor network platform may receive user-confirmed completion information uploaded by the smart gas object platform, or issue a door-to-door service plan to the smart gas object platform. In some embodiments, the smart gas sensor network platform may include a smart gas indoor installation engineering sensor network sub-platform and a smart gas indoor device sensor network sub-platform.

The smart gas object platform may be configured as a plurality of types of devices related to gas installation. For example, the smart gas object platform may be configured as a gas device (including a pipeline network device, such as a pipeline, a gas meter, etc.) and a device related to implementation of installation engineering (including an installation engineering vehicle, a testing device, etc.). In some embodiments, the smart gas object platform may include a smart gas indoor installation engineering object sub-platform and a smart gas indoor device object sub-platform. The smart gas indoor installation engineering object sub-platform corresponding to the smart gas indoor installation engineering sensor network sub-platform may upload data related to execution of the installation engineering to the smart gas indoor installation engineering sensor network sub-platform. The smart gas indoor device object sub-platform corresponding to the smart gas indoor device sensor network sub-platform may upload the data related to execution of the installation engineering to the smart gas indoor device sensor network sub-platform.

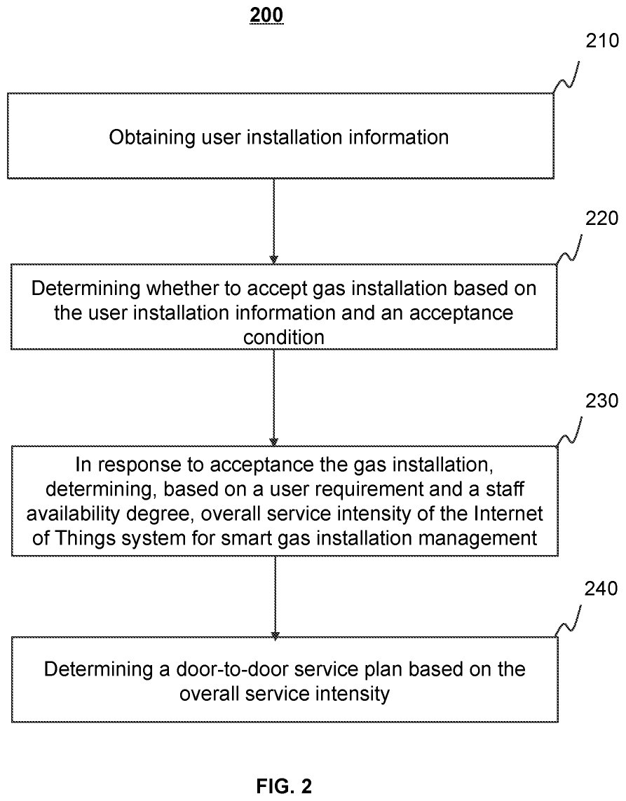

FIG. 2 is a flowchart illustrating an exemplary process for smart gas installation management according to some embodiments of the present disclosure. In some embodiments, the process 200 may be performed by the Internet of Things system 100 for smart gas installation management.

In 210, obtaining user installation information.

The user installation information may refer to information required to be provided by a user to apply for gas installation, such as an installation address, an installation time, etc. In some embodiments, the user installation information may include user information, property information, or any combination thereof.

The user information may refer to user identity information required to apply for gas installation. The user information may include a valid identification. For example, the valid identification may be obtained by the user uploading an identity card to a smart gas user platform or a third-party platform (e.g., an official account platform, a user service system, etc.). As another example, the valid identification may be obtained through face recognition by a camera of a terminal device taking a face image. The user information may further include a user type. For example, the user type may include one of industrial and commercial unit installation, developer centralization installation, and resident scatter installation. The user type may be obtained from information filled in the smart gas user platform by the user.

The property information may refer to house property information corresponding to an installation address of applying for gas installation. For example, the property information may include the property information (such as a property ownership certificate) of the installation address. The property information may be obtained from the information uploaded by the user in the smart gas user platform.

In some embodiments, the user installation information may be filled by the user in the smart gas user platform or the third-party platform (e.g., the official account platform, the user service system, etc.) on his/her own.

In 220, determining whether to accept gas installation based on the user installation information and an acceptance condition.

The acceptance condition may refer to a necessary condition for the gas installation application. For example, the acceptance condition may include presence of a supporting municipal gas pipeline buried near the installation address. In some embodiments, different user types may further correspond to different acceptance conditions. For example, when the user type is the industrial and commercial unit installation, the acceptance condition may further include that the user has a business license; when the user type is the developer centralization installation, the acceptance condition may further include obtaining consent of a housing and construction management office and an owner. The acceptance condition may be preset by a manager (e.g., a person who manages the Internet of Things system for smart gas installation management).

After the user installation information and the acceptance condition is obtained, it may be reviewed by a system or manually to determine whether to accept the gas installation. The review may include verifying authenticity of the information filled in by the user, and verifying whether the acceptance condition is satisfied, etc. When the review is passed, the acceptance of gas installation may be determined.

In 230, in response to the acceptance of the gas installation, determining, based on a user requirement and a staff availability degree, overall service intensity of the Internet of Things system for smart gas installation management.

The user requirement may refer to a related requirement that the user expects to receive a door-to-door service, for example, the user requirement may include a date, a time, and content (e.g., site survey, gas solution design, installation of pipeline natural gas, etc.) of the door-to-door service that the user expects to receive. The user requirement may be filled in by the user in the smart gas user platform on his/her own.

The staff availability degree may refer to a scheduling availability degree of staff. The staff may refer to persons who perform the door-to-door service. The staff availability degree may be represented by a numerical value. The larger the value, the higher the staff availability degree. In some embodiments, the staff availability degree may include the availability degree values corresponding to a plurality of staff. For example, the staff availability degree may be ([A, 0.8], [B, 0.6], . . . ), indicating that staff A has an availability degree of 0.8, staff B has an availability degree of 0.6, etc. In some embodiments, the staff availability degree may further refer to an overall availability degree value of all staff. For example, the staff availability degree may be ([Monday, 0.2], [Tuesday, 0.4], . . . ), indicating that the staff availability degree is 0.2 on Monday, 0.4 on Tuesday, etc.

In some embodiments, a smart gas operation management platform may determine the staff availability degree based on a staff scheduling condition. For example, if staff A has been scheduled for 3 hours on Jan. 1, 2023, and a daily working hours are 8 hours, the availability degree of the staff A on that day may be (8-3) 8=0.625.

The overall service intensity may refer to work intensity of the Internet of Things system for smart gas installation providing the door-to-door service. The overall service intensity may reflect a degree of balance between supply and demand of the Internet of Things system for smart gas installation management providing the door-to-door service. The overall service intensity may be indicated by a value greater than or equal to zero. When the overall service intensity is smaller than one, it may mean that a count of requirements per unit time is smaller than the count of services per unit time, i.e., a count of users waiting in line may decrease over time, and the Internet of Things system for smart gas installation management may operate efficiently. When the overall service intensity is equal to 1, it may mean that the count of requirements per unit time is equal to the count of services per unit time, i.e., the count of users waiting in line may remain basically unchanged over time, and the supply and demand of the Internet of Things system for smart gas installation management may be balanced. When the overall service intensity is greater than 1, it may mean that the count of user requirements per unit time is greater than the count of door-to-door services per unit time, i.e., the count of users waiting in line may increase over time, and load of the Internet of Things system for smart gas installation management may be too high to satisfy the user requirement in time.

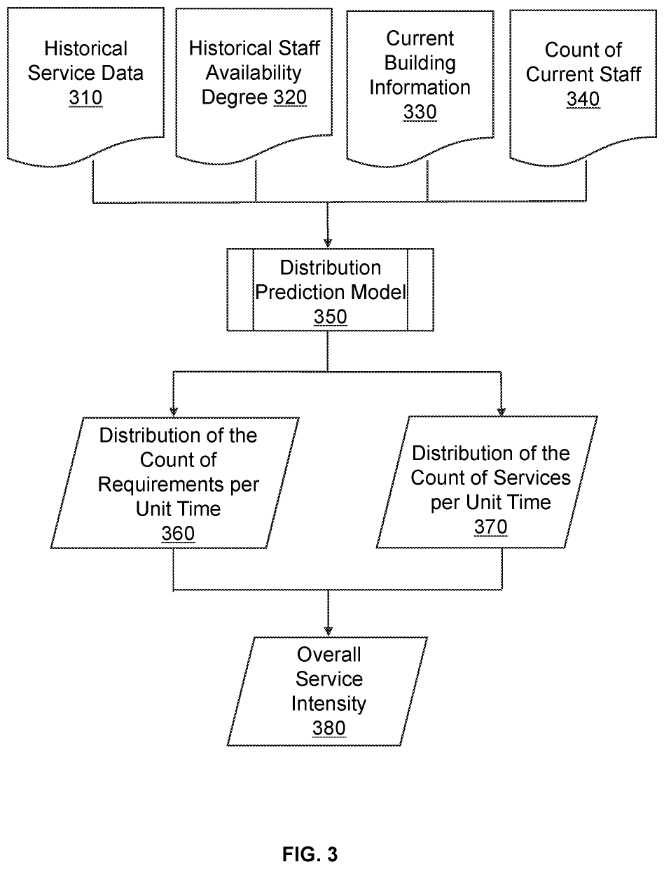

The count of requirements per unit time may refer to a count of user installation requirements accepted in a unit time, for example, 100 households/day. The count of services per unit time may refer to a count of door-to-door services performed by staff in a unit time, e.g., 120 households/day. Further description regarding the count of requirements per unit time and the count of services per unit time may be found in FIG. 3 and related description thereof.

In some embodiments, the smart gas operation management platform may determine the overall service intensity of the Internet of Things system for smart gas installation management based on the count of requirements per unit time and the count of services per unit time. For example, the count of user requirements and the count of door-to-door services on the day may be counted, and a ratio of the above two types of data may be configured as the overall service intensity of the Internet of Things system for smart gas installation management.

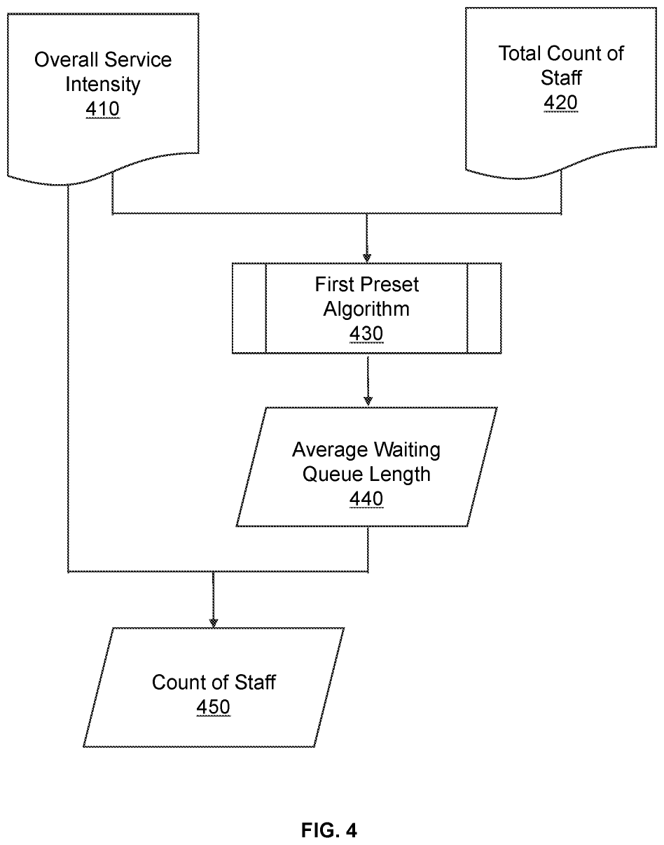

In some embodiments, the smart gas operation management platform may further determine the overall service intensity based on the distribution of the count of requirements per unit time and the distribution of the count of services per unit time. Further description regarding the determining the overall intensity may be found in FIG. 4 and related description thereof.

In 240, determining the door-to-door service plan based on the overall service intensity.

The door-to-door service plan may refer to a plan in which staff perform the gas installation door-to-door service. The door-to-door service may include the date, the time, person(s) (including a count of persons, etc.), the content (e.g., site survey, gas solution design, installation of pipeline natural gas, etc.), etc. of the door-to-door service.

In some embodiments, a user requirement may correspond to at least one door-to-door service plan. For example, the user requirement submitted by resident A may correspond to a door-to-door service plan 1 and a door-to-door service plan 2. The door-to-door service plan 1 may be that staff A conducts the door-to door site survey and gas solution design at 14:00 on Jan. 1, 2022, and the door-to-door service plan 2 may be that staff B conducts door-to-door installation of pipeline natural gas at 9:00 on Jan. 10, 2022.

In some embodiments, the smart gas operation management platform may determine the door-to-door service plan based on a degree of the overall service intensity. For example, when the overall service intensity is too strong on Monday, a door-to-door time of the door-to-door service plan may be determined to be Tuesday, etc.

In some embodiments, the smart gas operation management platform may adjust a count of staff and update the staff availability degree based on the overall service intensity.

In some embodiments, the smart gas operation management platform may adjust the count of staff and update the staff availability degree based on the overall service intensity and an intensity threshold. When the overall service intensity is greater than the intensity threshold, the smart gas operation management platform may increase the total count of staff until the overall service intensity is smaller than or equal to the intensity threshold to reduce the load of the Internet of Things system for smart gas installation management. At the same time, the availability degree of the new staff may be set to 1 and the availability degree of the original staff may be kept unchanged to update the staff availability degree. The intensity threshold may be a system default value, an empirical value, a manually pre-set value, or the like, or any combination thereof, which may be set according to an actual requirement, and is not limited in the present disclosure. For example, the intensity threshold may be set to 1. When the overall service intensity is consistently greater than 1, the Internet of Things system for smart gas installation management may not achieve the balance between supply and demand.

In some embodiments, the smart gas operation management platform may determine the door-to-door service plan based on the user requirement and the updated staff availability degree. For example, the smart gas operation management platform may determine a waiting queue based on the user requirement (e.g., queueing users based on the expected time of the door-to-door service in the user requirement to determine the waiting queue), thereby assigning a first user in the waiting queue to staff with a greatest updated staff availability degree to determine the door-to-door service plan. Exemplarily, if user A is a first place in the waiting queue, the expected date and time of the door-to-door service is 10:00 on Oct. 30, 2022, and the expected content of the door-to-door service is the site survey and the gas solution design, and the staff with the greatest updated availability degree is staff B, then the door-to-door service plan that staff B will conduct the door-to-door site survey and gas solution design at 10:00 on Oct. 30, 2022 may be determined.

In some embodiments of the present disclosure, when the overall service intensity is too large, increasing the count of staff and updating the staff availability degree can ensure that the Internet of Things system for smart gas installation management can continuously address the user requirement without making the user queue indefinitely.

In some embodiments, the smart gas operation management platform may further determine an average waiting queue length and adjust the count of staff based on the average waiting queue length and the overall service intensity. Further description regarding the adjusting the count of staff may be found in FIG. 4 and related description thereof.

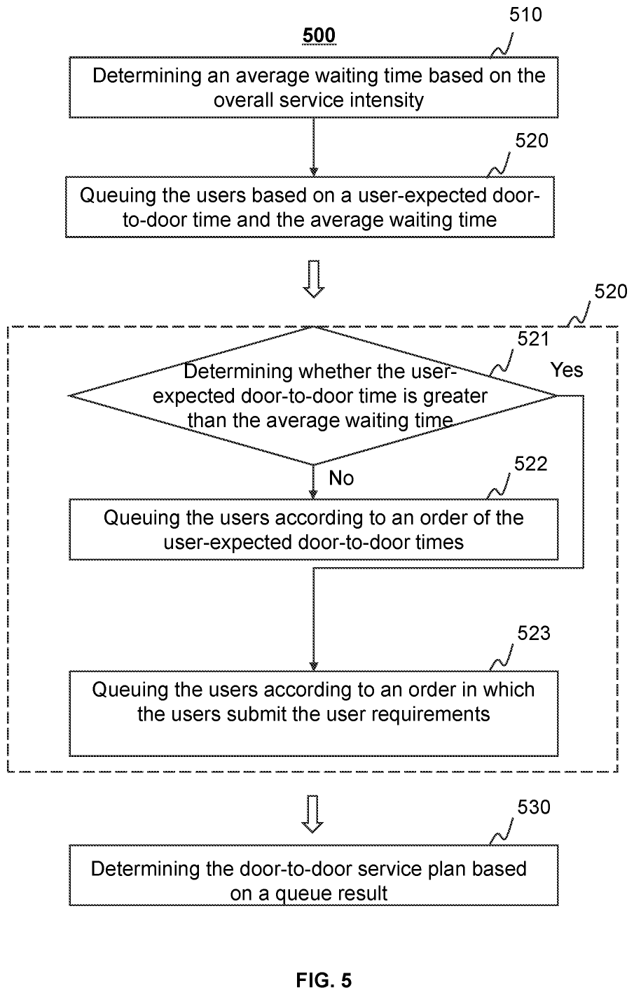

In some embodiments, the smart gas operation management platform may further determine an average waiting time based on the overall service intensity; queue the users based on a user-expected door-to-door time and the average waiting time; and then may determine the door-to-door service plan based on a queue result. Further description regarding the determining the door-to-door service plan based on the queue result may be found in FIG. 5 and related description thereof.

In some embodiments, in response to non-acceptance of the gas installation, the smart gas operation management platform may send a reason for not accepting the gas installation to a user and prompt the user to re-upload the user installation information. For example, the smart gas operation management platform may send the reason for not accepting the gas installation to the smart gas user platform through an smart gas service platform. The smart gas user platform may display the reason for not accepting the gas installation to the user and prompt the user to re-upload the user installation information. An exemplary prompting mode may include, but is not limited to, voice prompting, text prompting, etc. For example, when clarity of the image taken during the user face recognition does not satisfy the requirement, the smart gas user platform may prompt the user by voice prompt to retake the face image in a place with a better lighting condition.

In some embodiments, the smart gas operation management platform may re-determine whether to accept gas installation based on the re-uploaded user installation information.

In some embodiments of the present disclosure, the determination of gas installation and the door-to-door service plan may be completed through the Internet of Things system for smart gas installation management, and the user may complete the application and data upload of gas installation online without leaving home, which can avoid tedious offline application and save the cost of the gas installation. The user may further check the progress of the gas installation process in real time on a user side, effectively enhancing the user experience. At the same time, the Internet of Things system for smart gas installation management may determine the door-to-door service plan in a targeted way based on the user requirement and the overall service situation, thereby effectively reducing user's waiting costs.

FIG. 3 is an exemplary schematic diagram illustrating determining overall service intensity according to some embodiments of the present disclosure.

In some embodiments, the smart gas operation management platform may determine distribution of a count of requirements per unit time of gas installation and distribution of a count of services per unit time of gas installation based on a user requirement and a staff availability degree.

The distribution of the count of requirements per unit time may refer to a probability that the count of requirements per unit time is distributed in an interval of the count of requirements. The intervals of the count of requirements may refer to different intervals divided according to different counts of requirements. For example, the interval of the count of requirements may include 0 to 10, 11 to 20, etc., and 0 to 10 may mean that the count of requirements is between 0 and 10 services. For example, the distribution of the count of requirements per unit time may be ([0˜10], 0.7), ([11-˜20], 0.3), indicating that the probability of the count of requirements per unit time being in the interval of the count of requirements of 0˜10 is 0.7, and the probability of the count of requirements per unit time being in the interval of the count of requirements of 11˜20 is 0.3. Further description regarding the count of requirements per unit time may be found in the operation 230 and related description thereof.

The distribution of the count of requirements per unit time may be obtained by statistical analysis of historical data. An exemplary statistical analysis mode may include, but is not limited to, maximum likelihood estimation, moment estimation, etc.

The distribution of the count of services per unit time may refer to a probability that the count of services per unit time is distributed in the an interval of the count of services. The intervals count of services may refer to different intervals divided according to different counts of services. For example, the interval of the count of services may include 0 to 10, 11 to 20, etc. For example, the distribution of the count of services per unit time may be ([0˜10], 0.4), ([11˜20], 0.6), indicating that the probability that the count of services per unit time being in the interval of the count of services of 0˜10 is 0.4, and the probability that the count of services per unit time being in the interval of the count of services of 11˜20 is 0.6. Further description regarding the count of services per unit time may be found in the operation 230 and related description thereof.

Similar to the distribution of the count of requirements per unit time, the distribution of the count of requirements per unit time may further be obtained by the statistical analysis of the historical data, which is not be repeated herein.

In some embodiments, the smart gas operation management platform may determine the distribution of the count of requirements per unit time 360 and the distribution of the count of services per unit time 370 by processing historical service data 310 and a historical staff availability degree 320, current building information 330, and a count of current staff 340 through a distribution prediction model 350.

The distribution prediction model may be a machine learning model. For example, the distribution prediction model may include a recurrent neural networks model, a convolutional neural networks model, other custom model structures, or the like, or any combination thereof.

As shown in FIG. 3, an input of the distribution prediction model 350 may include the historical service data 310, the historical staff availability degree 320, the current building information 330, and the count of current staff 340, and an output may include the distribution of the count of requirements per unit time 360 and the distribution of the count of services per unit time 370.

The historical service data may include data related to historical acceptance and historical services of gas installation. For example, the historical service data may include a count of accepted services and a count of door-to-door services in the past year.

The historical staff availability degree may refer to a staff availability degree at a time a historical door-to-door service is performed. For example, the historical staff availability degree may refer to a staff availability degree for each day in the past year. The historical service data and the historical staff availability degree may be determined based on historical service records of the Internet of Things system for smart gas installation management.

The current building information may refer to relevant information of the building in the near future. For example, the current building information may include a count of newly built buildings, transactions, etc. in the last month. The current building information may be obtained from a web database.

The count of current staff may refer to a count of staff currently available to perform the door-to-door service. For example, the count of current staff may include a count of staff available to perform the door-to-door services that day.

The distribution prediction model 350 may be obtained based on a large number of first training samples with labels, for example, a plurality of first training samples with first labels may be input to an initial distribution prediction model, a loss function may be constructed from the first labels and a result of the initial distribution prediction model, and parameters of the initial distribution prediction model may be updated iteratively based on the loss function by gradient descent or other modes. The model training may be completed when a preset condition is satisfied, and a trained distribution prediction model 350 may be obtained. The preset condition may be that the loss function converges, a count of iterations reaches a threshold value, etc.

In some embodiments, the first training sample for training the distribution prediction model may include the historical service data, historical building information, the historical staff availability degree, and a total count of historical staff over a historical period of time. The first training sample may be obtained based on historical data. The first label may be the interval of the count of requirements in which an actual average count of requirements per unit time is located and the interval of the count of services in which an actual average count of services per unit time is located in the above historical period of time. The first label may be manually labeled. For example, the interval of the count of requirements in which an actual average count of requirements per unit time is located or the interval of the count of services in which an actual average count of services per unit time is located may be labeled as 1, and remaining intervals may be labeled as 0. For example, if the count of requirements per unit time in the historical period of time is distributed in an interval of the count of requirements of [11˜20], the interval of the count of requirements of [11˜20] may be labeled as 1, and remaining intervals of the count of requirements (e.g., [0-10]) as 0, etc.

In some embodiments, the smart gas operation management platform may determine the overall service intensity 380 based on the distribution of the count of requirements per unit time 360 and the distribution of the count of services per unit time 370, e.g., the overall service intensity may be determined based on the distribution of the count of requirements per unit time and the distribution of the count of services per unit time through a relevant calculation mode. An exemplary calculation mode is shown in equation (1) below:

$$ρ = \frac{{\sum }_{i} {λ}_{i} {p}_{i}}{{\sum }_{k} {μ}_{k} qk} \qquad ( 1 )$$

where ρ denotes the overall service intensity, reflecting busyness of the entire Internet of Things system for smart gas installation management, and the larger the ρ, the greater the busyness, and the more short-staffed.
λ denotes the count of requirements per unit time. λ₁, λ₂, . . . λᵢ denote different intervals of the count of requirements. ρ₁, ρ₂, . . . ρᵢ respectively denotes a probability that the count of requirements is distributed in the corresponding interval of the count of requirements.
i and λ₁, λ₂, . . . λᵢ may be determined manually, for example, when i=11, λ₁ denotes the interval of the count of requirements of [0˜10], λ₂ denotes the interval of the count of requirements of [11˜20], . . . λ₁₀ denotes the interval of the count of requirements of [91˜100], and λ₁₁ denotes the interval of the count of requirements of above 100, and the probabilities ρ₁˜ρᵢ may be 5%, 6%, . . . 1%, respectively, indicating the probability of the count of requirements is distributed in the above interval of the count of requirements.
μ denotes the count of services per unit time. μ₁, μ₂, . . . μₖ denote different intervals of count of services. q₁, q₂, . . . qₖ respectively denotes a the probability that the count of services is distributed in the corresponding interval of the count of services.
k and μ₁, μ₂, . . . μₖ may be determined manually, for example, when k=5, μ₁ denotes the interval of the count of services of [0˜30], μ₂ denotes the interval of the count of services of [31˜60], . . . μ₅ denotes the interval of the count of services of above 150, and the probabilities q₁˜qₖ may be 1%, 10%, . . . 2%, respectively, indicating the probability of the count of services is distributed in the above interval of the count of services. i and k may be different values.

In some embodiments of the present disclosure, the distribution of the count of requirements per unit time and the distribution of the count of services per unit time may be determined based on the distribution prediction model, so that the overall service intensity may be reasonably predict, thereby avoiding overloading of the platform and users waiting too long, and further improving the user experience.

FIG. 4 is an exemplary schematic diagram illustrating adjusting a count of staff according to some embodiments of the present disclosure.

In some embodiments, the smart gas operation management platform may adjust the count of staff 450 by determining the average waiting queue length 440 based on the overall service intensity 410 and the average waiting queue length 440.

The average waiting queue length may refer to an average count of services that each user needs to wait for. For example, if there are 5 users a, b, c, d, and e, where a, b and c are in a queue corresponding to staff A, and d and e are in a queue corresponding to staff B, then the count of services that the 5 users need to wait for may be 1, 1, 2, 0 and 1, respectively, and then the average waiting queue length may be the average count of services of 1 service.

In some embodiments, the smart gas operation management platform may perform statistical analysis on a historical queuing situation to determine an average waiting queue length. For example, the queuing situation of all users over the past 100 days may be counted and an average value of the waiting queue length of each of all the users may be used as the average waiting queue length.

In some embodiments, the smart gas operation management platform may further determine the average waiting queue length 440 through a first preset algorithm 430 based on the overall service intensity 410 and the total count of staff 420.

The first preset algorithm may refer to an algorithm that estimates the average waiting queue length according to a certain rule.

In some embodiments, under a certain assumed condition, the smart gas operation management platform may determine the average waiting queue length through the first preset algorithm based on the overall service intensity and the total count of staff. The assumed condition may include that a count of persons that can be accommodated in the queue is infinite, a submission time of the user requirement follows Poisson Distribution, and a time of the staff performing a door-to-door service follows Negative Exponential Distribution, and a plurality of staff serve in parallel. Serving in parallel may mean that different staff can provide door-to-door services to different users respectively at the same time.

Merely by way of example, equation (2) of the first preset algorithm is as follows.

$${L}_{s} = s ρ + \frac{{( s ρ )}^{s} ρ}{s ! {( 1 - ρ )}^{2}} {ρ}_{0} \qquad ( 2 )$$

where Lₛ denotes the average waiting queue length, s denotes the total count of staff, p denotes the overall service intensity, ρ₀ denotes a probability that all staff are available, and the exemplary equation (3) of ρ₀ is as follows:

$${ρ}_{0} = {[ {\sum }_{k = 0}^{s - 1} \frac{{( s ρ )}^{k}}{k !} + \frac{{( s ρ )}^{s}}{s ! ( 1 - ρ )} ]}^{- 1} \qquad ( 3 )$$

where k may be any integer value from 0, 1, 2 . . . to s−1 in turn.

In some embodiments, the smart gas operation management platform may comprehensively score to form a service score of the Internet of Things system for smart gas installation management based on the overall service intensity and the average waiting queue length. The service score may be negatively correlated with the overall service intensity and negatively correlated with the average waiting queue length. For example, the larger the overall service intensity, the smaller the service score. As another example, the longer the average waiting queue length, the smaller the service score. When the service score is smaller than a score threshold, the total count of staff may be increased until the service score is greater than or equal to the score threshold. The score threshold may be a system default value, an empirical value, a manually pre-set value, or the like, or any combination thereof, which may be set according to an actual requirement, and is not limited in the present disclosure.

In some embodiments of the present disclosure, by adjusting the total count of staff, the overall service intensity and average waiting queue length of the smart gas installation management platform may be kept within a certain range, thereby avoiding the overloading of the platform and the users waiting too long, and further enhancing the user experience.

FIG. 5 is a flowchart illustrating an exemplary process for determining a door-to-door service plan according to some embodiments of the present disclosure.

In 510, determining an average waiting time based on the overall service intensity.

The average waiting time may refer to an average value of time it takes for each user waiting for a door-to-door service. For example, if 2 users, A, and B spend 1 hour and 3 hours waiting for a door-to-door service, respectively, the average waiting time may be 2 hours.

In some embodiments, the smart gas operation management platform may determine the average waiting time by performing statistical analysis on historical data. For example, the waiting times of all users over the past 10 days may be calculated and an average value of the waiting times of all the users may be used as the average waiting time.

In some embodiments, the smart gas operation management platform may determine the average waiting time through a second preset algorithm based on the average waiting queue length, the user requirement, and the staff availability degree.

The second preset algorithm may refer to an algorithm that calculates the average waiting time according to a certain rule. Merely by way of example, the equation (4) of the second preset algorithm is as follows.

$${W}_{q} = {W}_{S} - \frac{1}{μ} \qquad ( 4 )$$

where W_{q} denotes the average waiting time, p denotes the count of services per unit time, W_{S} denotes a sojourn time (i.e., the time from a moment the user applies for a service to a moment the gas installation service is completed), and the exemplary calculation equation (5) of W_{S} is as follows.

$${W}_{S} = \frac{{L}_{S}}{λ} \qquad ( 5 )$$

where λ denotes the count of requirements per unit time, Lₛ denotes the average waiting queue length. Further description regarding the average waiting queue length, the user requirement, and the staff availability degree may be found in FIG. 2, FIG. 3 and related description thereof.

In 520, queuing the users based on a user-expected door-to-door time and the average waiting time.

How the users queue is illustratively described through the operations 521-523 as follows.

In 521, determining whether the user-expected door-to-door time is greater than the average waiting time.

The user-expected door-to-door time may be input by the user in the smart gas user platform.

In some embodiments, the smart gas operation management platform may determine whether the user-expected door-to-door time is greater than the average waiting time. For example, if the user submits a user requirement at 11:00, the user-expected door-to-door time is 14:00 (i.e., the user-expected door-to-door time is in 3 h), and the average waiting time is 2 h, the user-expected door-to-door time (3 h) is greater than the average waiting time (2 h).

In 522, in response to a determination that the user-expected door-to-door time is smaller than or equal to the average waiting time, queuing the users according to an order of the user-expected door-to-door times.

The order of the user-expected door-to-door times (hereafter referred to as a first order) may refer to an order obtained by arranging the user-expected door-to-door times in order. For example, if user A's user-expected door-to-door time is 13:00, user B's user-expected door-to-door time is 12:00, and user C's user-expected door-to-door time is 14:00, the first order may be: user B>user A>user C. “>” denotes time priority.

In some embodiments, the smart gas operation management platform may queue the users according to the first order when the user-expected door-to-door time is smaller than or equal to the average waiting time. When the user-expected door-to-door time is smaller than or equal to the average waiting time, the smart gas operation management platform may prioritize the door-to-door service for a top-ranked user in the first order. For example, if the average waiting time is 3.5 h and a current time is 11:00, the expected door-to-door times of user A and user B in the above example are smaller than or equal to the average waiting time, the door-to-door service may be provided to user B first according to the first order, and then to user A and user C in turn.

In 523, in response to a determination that the user-expected door-to-door time is greater than the average waiting time, queuing the users according to an order in which the users submit the user requirements.

The order in which the users submit the user requirements (hereafter referred to as a second order) may refer to an order in which the users submit the user requirements in terms of time. For example, for user A, user B, and user C in the above example, if user A submits a user requirement (i.e., applying for gas installation) at 11:00, user B submits a user requirement at 09:30, and user C submits a user requirement at 10:00, the second order may be: user B>user C>user A. “>” denotes time priority.

In some embodiments, when the user-expected door-to-door time is greater than the average waiting time, the smart gas operation management platform may queue the users according to the order in which the users submit the user requirements. When the user-expected door-to-door time is greater than the average waiting time, the smart gas operation management platform may prioritize door-to-door service for a top-ranked user in the second order. For example, if the average waiting time is 0.5 h and a current time is 11:00, and the expected door-to-door times of user A, user B, and user C in the above example are greater than the average waiting time, the door-to-door service may be provided to user B first according to the second order, and then to user C and user A in turn.

In 530, determining the door-to-door service plan based on a queue result.

The queue result may refer to a result of queuing the users based on first order or the second order. For example, the queue result may be user B>user A>user C.

In some embodiments, the smart gas operation management platform may determine the door-to-door service plan based on the queue result. For example, when the user-expected door-to-door time is smaller than or equal to the average waiting time, the smart gas operation management platform may queue the users according to the queue result of the first order. When the expected door-to-door time is greater than the average waiting time, the smart gas operation management platform may queue the users according to the queue result of the second order, which will not be repeated herein.

In some embodiments of the present disclosure, the users may be queued according to different orders based on the expected door-to-door time and average waiting time, so that the user requirements may be sorted according to urgency, a user with an urgent need may be prioritized, and a user with a less urgent need may be queued in a first-come, first-served manner, which can optimize resource allocation and ensure user experience.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for smart gas installation management implemented based on an Internet of Things system for smart gas installation management, comprising:
obtaining user installation information, wherein the user installation information includes at least one of user information or property information;
determining whether to accept gas installation based on the user installation information and an acceptance condition;
in response to acceptance of the gas installation, determining, based on a user requirement and a staff availability degree, overall service intensity of the Internet of Things system for smart gas installation management; and
determining a door-to-door service plan based on the overall service intensity.

2. The method for smart gas installation management of claim 1, wherein the Internet of Things system for smart gas installation management comprises: a smart gas user platform, a smart gas service platform, a smart gas operation management platform, a smart gas sensor network platform, and a smart gas object platform, and the smart gas operation management platform comprises a smart gas indoor installation management sub-platform and a smart gas data center, wherein
the smart gas data center obtains the user installation information from the smart gas user platform through the smart gas service platform and sends the user installation information to the smart gas indoor installation management sub-platform; and
the smart gas indoor installation management sub-platform determines the door-to-door service plan for a user after receiving the user installation information.

3. The method for smart gas installation management of claim 1, wherein the determining, based on a user requirement and a staff availability degree, overall service intensity of the Internet of Things system for smart gas installation management includes:
determining, based on the user requirement and the staff availability degree, distribution of a count of requirements per unit time of the gas installation and distribution of a count of services per unit time of the gas installation; and
determining, based on the distribution of the count of requirements per unit time and the distribution of the count of services per unit time, the overall service intensity.

4. The method for smart gas installation management of claim 3, wherein the determining, based on the user requirement and the staff availability degree, distribution of a count of requirements per unit time of the gas installation and distribution of a count of services per unit time of the gas installation includes:
determining the distribution of a count of requirements per unit time and the distribution of a count of services per unit time by processing historical service data, a historical staff availability degree, current building information, and a count of current staff based on a distribution prediction model, wherein the distribution prediction model is a machine learning model.

5. The method for smart gas installation management of claim 1, wherein the determining a door-to-door service plan based on the overall service intensity includes:
adjusting a count of staff and updating the staff availability degree based on the overall service intensity; and
determining the door-to-door service based on the user requirement and the updated staff availability degree.

6. The method for smart gas installation management of claim 5, wherein the adjusting a count of staff based on the overall service intensity includes:
determining an average waiting queue length; and
adjusting the count of staff based on the overall service intensity and the average waiting queue length.

7. The method for smart gas installation management of claim 6, wherein the determining an average waiting queue length includes:
determining, based on the overall service intensity and a total count of staff, the average waiting queue length through a first preset algorithm.

8. The method for smart gas installation management of claim 1, wherein the determining a door-to-door service plan based on the overall service intensity includes:
determining an average waiting time based on the overall service intensity; and
queuing, based on a user-expected door-to-door time and the average waiting time, the users, including:
in response to a determination that the user-expected door-to-door time is smaller than or equal to the average waiting time, queuing the users according to an order of the user-expected door-to-door times; or
in response to a determination that the user-expected door-to-door time is greater than the average waiting time, queuing the users according to an order in which the users submit the user requirements; and
determining the door-to-door service plan based on a queue result.

9. The method for smart gas installation management of claim 8, wherein the determining an average waiting time based on the overall service intensity includes:
determining, based on the average waiting queue length, the user requirement, and the staff availability degree, the average waiting time through a second preset algorithm.

10. The method for smart gas installation management of claim 1, further comprising:
in response to non-acceptance of the gas installation, sending a reason for not accepting the gas installation to a user and prompting the user to re-upload user installation information; and
re-determining whether to accept gas installation based on the re-uploaded user installation information.

11. An Internet of Things system for smart gas installation management, comprising: a smart gas user platform, a smart gas service platform, a smart gas operation management platform, a smart gas sensor network platform, and a smart gas object platform, wherein the smart gas operation management platform comprises a smart gas indoor installation management sub-platform and a smart gas data center,
the smart gas data center is configured to obtain user installation information from the smart gas user platform through the smart gas service platform and send the user installation information to the smart gas indoor installation management sub-platform; and
the smart gas indoor management sub-platform is configured to:
obtain the user installation information, wherein the user installation information comprising at least one of user information or property information;
determine whether to accept gas installation based on the user installation information and an acceptance condition;
in response to acceptance of the gas installation, determine, based on a user requirement and a staff availability degree, overall service intensity of the Internet of Things system for smart gas installation management; and
determine a door-to-door service plan based on the overall service intensity.

12. The Internet of Things system for smart gas installation management of claim 11, wherein to determine, based on a user requirement and a staff availability degree, overall service intensity of the Internet of Things system for smart gas installation management, the smart gas installation management sub-platform is configured to:
determine, based on the user requirement and the staff availability degree, distribution of a count of requirements per unit time of the gas installation and distribution of a count of services per unit time of the gas installation; and
determine, based on the distribution of the count of requirements per unit time and the distribution of the count of services per unit time, the overall service intensity.

13. The Internet of Things system for smart gas installation management of claim 12, wherein to determine, based on the user requirement and the staff availability degree, distribution of a count of requirements per unit time of the gas installation and distribution of a count of services per unit time of the gas installation, the smart gas installation management sub-platform is configured to:
determine the distribution of a count of requirements per unit time and the distribution of a count of services per unit time by processing historical service data, a historical staff availability degrees, current building information, and a count of current staff based on a distribution prediction model, wherein the distribution prediction model is a machine learning model.

14. The Internet of Things system for smart gas installation management of claim 11, wherein to determine a door-to-door service plan based on the overall service intensity, the smart gas installation management sub-platform is configured to:
adjust a count of staff and update the staff availability degree based on the overall service intensity; and
determine the door-to-door service based on the user requirement and the updated staff availability degree.

15. The Internet of Things system for smart gas installation management of claim 14, wherein to adjust a count of staff based on the overall service intensity, the smart indoor installation management sub-platform is configured to:
determine an average waiting queue length; and
adjust the count of staff based on the overall service intensity and the average waiting queue length.

16. The Internet of Things system for smart gas installation management of claim 15, wherein to determine an average waiting queue length, the smart gas installation management sub-platform is configured to:
determine, based on the overall service intensity and a total count of staff, the average waiting queue length through a first preset algorithm.

17. The Internet of Things system for smart gas installation management of claim 11, wherein to determine a door-to-door service plan based on overall service intensity, the smart gas door-to-door installation management sub-platform is configured to:
determine an average waiting time based on the overall service intensity; and
queue, based on a user-expected door-to-door time and the average waiting time, the users, including:
in response to a determination that the user-expected door-to-door time is smaller than or equal to the average waiting time, queuing the users according to an order of the user-expected door-to-door times; or
in response to a determination that the user-expected door-to-door time is greater than the average waiting time, queuing the users according to the order in which the users submit the user requirements; and
determining the door-to-door service plan based on a queue result.

18. The Internet of Things system for smart gas installation management of claim 17, wherein to determine an average waiting time based on the overall service intensity, the smart gas installation management sub-platform is configured to:
determine, based on the average waiting queue length, the user requirement, and the staff availability degree, the average waiting time through a second preset algorithm.

19. The Internet of Things system for smart gas installation management of claim 11, wherein smart gas indoor installation management platform is further configured to:
in response to non-acceptance of the gas installation, send a reason for not accepting the gas installation to a user and prompt the user to re-upload user installation information; and
re-determine whether to accept gas installation based on the re-uploaded user installation information.

20. A non-transitory computer-readable storage medium storing computer instructions, wherein when the computer instructions are executed by a processor, the method for smart gas installation management of any claim 1 is implemented.
